(19) United States
(12) Patent Application Publication
(10) Pub. No.: US 2005/0182698 A1
(43) Pub. Date: Aug. 18, 2005

(54) Report generation and distribution system and method for a time and attendance recording system

(76) Inventors: Luis Garcia, Slinger, WI (US); Bryan D. Dickerson, Hartford, WI (US); Jeffrey H. Peterson, Germantown, WI (US); Dennis J. Thornton, Hartford, WI (US); Paul R. Hutchinson, Hartford, WI (US); Douglas M. Wilkison, Hartford, WI (US); James A. Hennen, Hartford, WI (US)

Correspondence Address: QUARLES & BRADY LLP, 411 E. WISCONSIN AVENUE, SUITE 2040, MILWAUKEE, WI, 53202-4497, US

(21) Appl. No.: 10/778,407

(22) Filed: Feb. 16, 2004

(51) Int. Cl. G06F 17/60

(52) U.S. Cl. 705/30

(57) ABSTRACT

A computer system records when employees enter and exit a workplace, thereby producing time and attendance data for each employee. Each supervisor is able to configure computer generated reports that contain designated information about the employees for whom a respective supervisor is responsible. A separate summary data file stores report data for each employee and the report data are updated automatically as the employee completes a period of work. The supervisor creates a report profile which specifies items of report data that are to appear on a particular report and whether only employees with an item of report data within a selected range are to appear. Reports are produced for a supervisor by using the respective report profile and summary data files for those employees associated with that supervisor.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to computer systems for recording employees regular work hours, overtime, absences due to sickness, and vacation time; and more particularly to the generation of reports of employee time and attendance information by such computer systems.

2. Description of the Related Art

Many employees are compensated based on the number of hours that they work during a pay period, which may be weekly, bi-weekly, semi-monthly or monthly. Labor wage and hour laws restrict the number of hours that certain classes of employees may work during defined time periods. In other cases, after a specified number of hours have been worked in a single day or week, the employee is entitled to receive a higher level of compensation for additional work hours. Failure to abide by these laws can result in the government assessing stiff penalties against the employer. Therefore, it is essential that business keep accurate records of how many hours certain employees work each day.

Historically employees used a time clock to record the time of day on an attendance card whenever they entered and exited the workplace. Today computerized time and attendance systems have replaced the traditional time clocks. These systems utilize devices that read data from employee identification badges upon entering and leaving the workplace. The employee identification data are transmitted and recorded in a central computer along with the current date and time. That recorded information is used subsequently by a payroll program to calculate the amount of wages that each employee is to receive.

Employers also utilize computerized scheduling systems which assign workers to different work shifts during a future pay period. The resultant schedule is printed and provided to each employee prior to commencement of that pay period, thus informing the employee when to report for work and the duration of each work period. In many businesses, an employee's work schedule can vary from day to day and week to week. In a hospital for example, one employee may be assigned to work eight hours during each of five consecutive days, while another employee will work four consecutive ten hour days and then not have to report to work for the next three consecutive days. Part-time employees may work less than an eight hour day or only a few days a week. Some employees may be called in to work unscheduled hours, such as when emergency repairs are needed, or when great amount of work has to be performed at the business. Thus the time and attendance system must be able to track a wide variety of scheduled and unscheduled work periods.

Traditional time and attendance systems determine whether a particular employee is entitled to overtime compensation based on the hours that they actually work during a given reporting period and based on the overtime rules that apply to that employee. Heretofore unless a person was scheduled to work overtime, a supervisor usually became aware of an overtime situation only after an employee was entitled to overtime compensation. By then it was too late for the supervisor to change an employee's work schedule or take other measures to avoid the accrual of overtime compensation as a result of unscheduled work hours. More recent time and attendance system are able to predict when an employee will incur overtime based on number of hours already worked and the amount of scheduled time yet to be worked during the pay period. Thus the supervisor can be warned of the potential overtime before it occurs.

Therefore it is desirable to provide a system by which a supervisor can receive up to the minute reports about the working hours of employees for whom the supervisor is responsible.

### SUMMARY OF THE INVENTION

A report is generated from time and attendance data that are stored in a computer system for a plurality of employees. The computer system records when employees enter and exit a workplace, thereby producing time and attendance data for each employee.

The report generation procedure derives a plurality of items of report data such as by performing arithmetic calculations on specific time and attendance data values. For example, the total number of hours worked by an employee is automatically derived by summing the number of hours that employee worked each day of a pay period. A summary data file, created for each employee, provides storage locations for the items of report data. Thereafter, whenever a given item of time and attendance data for a given employee changes, the summary data file for that employee is updated by changing the contents of the storage locations for the items of report data which are derived from that given item of time and attendance data.

In order to generate a report for each supervisor, an indication of a supervisor associated with each employee is stored in the computer system. A report profile is created that designates which of the items of report data are to appear on a particular type of report and how that report type is organized. When requested, a report for a given supervisor is produced using the report profile and summary data files for those employees indicated as associated with that supervisor.

### BRIEF DESCRIPTION OF THE DRAWINGS

FIG. 1 is a schematic diagram of a computer system for scheduling employee work time, recording time and attendance information and reporting that information to supervisory personnel;

FIG. 2 depicts the structure of time and attendance data recorded in the computer system for each work shift;

FIG. 3 represents a data structure used to store time and attendance data for each employee;

FIG. 4 shows a data structure of data denoting work periods that are scheduled for the employees;

FIG. 5 is a flowchart of the process for creating a report format used to present employee time and attendance information;

FIG. 6 depicts a table of data for a given employee which are available to be incorporated into a report;

FIG. 7 represents data table that defines the format of a given report created by a supervisor;

FIG. 8 is a flowchart of the process for making the data for specific employees available for viewing by one or more supervisors;

FIG. 9 is a flowchart of the process for updating an employee's data that is used in preparing reports;

FIG. 10 depicts a record of employee summary data stored for the report generation and distribution system for each employee;

FIG. 11 depicts a record of supervisor summary data stored by the report generation and distribution system for each supervisor for whom reports are produced;

FIG. 12 is a flowchart of the process by which data for a report is tabulated and displayed;

FIG. 13 is an exemplary report displaying time and attendance information for several Employees; and

FIG. 14 is a flowchart of a procedure by which one supervisor's reports are forwarded to another supervisor.

### DETAILED DESCRIPTION OF THE INVENTION

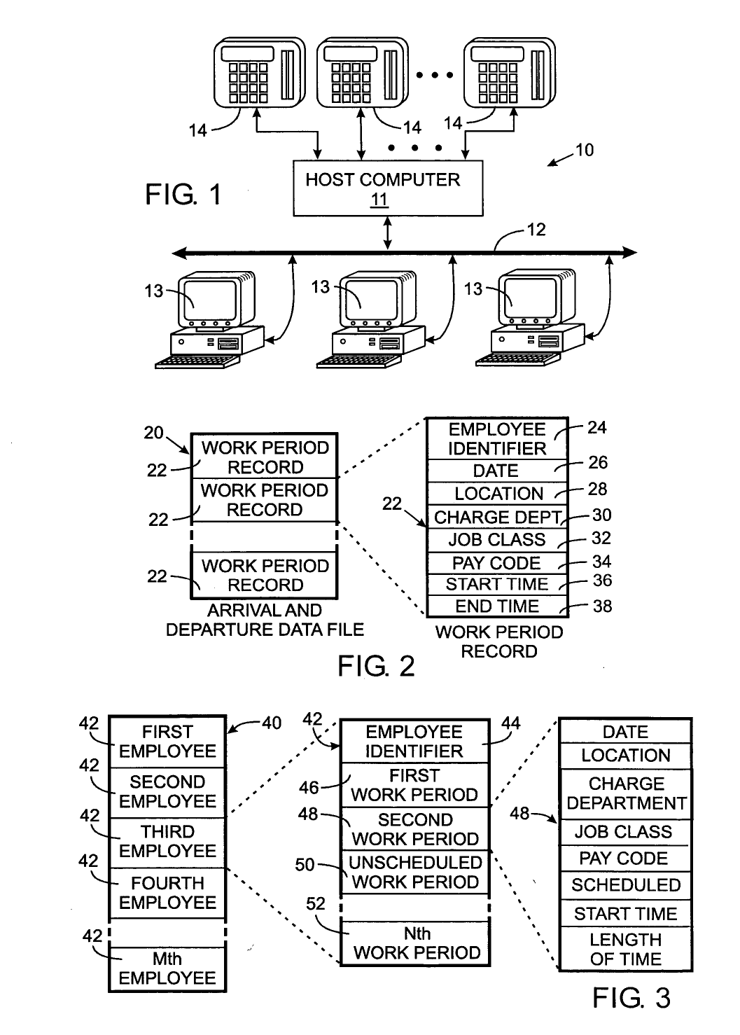

FIG. 1 illustrates a labor management computer system 10 for scheduling work periods for employees, recording the actual time worked by each employee, and storing other types of labor management data. As used herein labor management data includes, but is not limited to time and attendance information, employee licensing and certification records, employee productivity data and other human resource information regarding employees. The labor management computer system 10 also produces and displays reports based on the labor management data. Such reports may be displayed on a computer monitor or printed in hardcopy form. This system 10 comprises a host computer 11 which executes software programs that perform those functions, and stores the work schedules and the time and attendance data. The host computer is connected to a conventional communication network 12 of a type commonly found in workplaces. A plurality of personal computers 13 is connected to the communication network 12 to exchange data and commands with the host computer 11. Other personal computers may connect to the host computer 11 via dial-up telephone lines, the Internet and similar connections. A plurality of badge readers 14, used by employees to indicate when they start and end periods of work, are located throughout the workplace and are connected to the host computer 11. The badge readers 14 can take any of a number of commercially available forms. For example, each employee identification badge can have a magnetic strip that encodes a unique employee number and the magnetic strip is read when the employee swipes the identification badge through a slot of a badge reader. Each badge reader 14 also has a keypad by which an employee can enter other information into the time and attendance system 10. A display device on each card reader 14 presents information to the employee.

Supervisory personnel use the personal computers 13 to enter employee scheduling information into the host computer 11 and subsequently check and alter the work schedule as necessary. For example, when an employee calls in sick, a supervisor changes the schedule to substitute another employee for the absent worker. Any of several commercially available computer programs, such as the ActiveStaffer® Series available from API Software, Inc. of Hartford, Wis., U.S.A., can be executed by the host computer 11 to create and store work schedules for employees at a particular workplace.

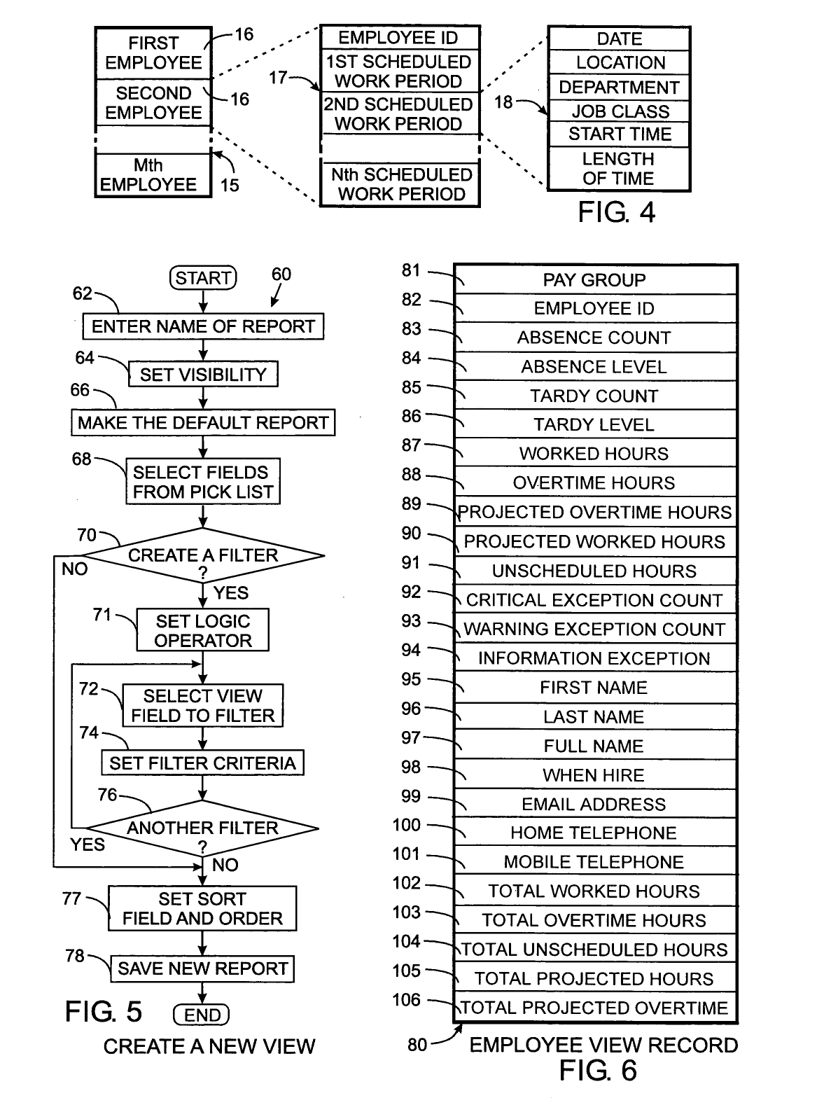

FIG. 4 depicts a file 15 of data created by such a scheduling program. This file 15 contains a record 16 for each employee being scheduled and that record holds sub-records 17 for each scheduled work period. For each such, work period information 18 is provided specifying the date, location and department in which the work will occur as well as the job classification or the work. The start time and length of the scheduled work period also are specified.

The host computer 11 also executes a standard time and attendance software program, such as the API LaborWorkx™ series also available from API Software, Inc. This type of program records the arrival and departure times of the employees within the business facility. Upon entering or exiting the workplace employees swipe a magnetically encoded employee badge through one of the readers 14. This provides an identification of the employee to the host computer 11 which logs that identification along with the date and time of day at which the event occurred in an arrival and departure data file 20 stored in memory.

With reference to FIG. 2, the arrival and departure data file 20 stores a plurality of records 22, each containing information related to a period of time actually worked by an employee. A different one of those records 22 is created whenever an employee enters the workplace. Each work period record 22 has a first field 24 that contains the identifier for the associated employee and a second field 26 stores the date on which the work period started. Three fields 28, 30, and 32 contain labor distribution information obtained from the corresponding assignment record in the scheduling data file stored elsewhere. Field 28 identifies the location at which the work was performed, and field 30 specifies the department that is to be charged for this work. Another field 32 provides the job class for this work period, while field 34 stores the pay code that is used to determine the wage for this assignment. In the event that this particular work period relates to an unscheduled assignment, for example an emergency for which the employee was called into work, the labor distribution information in fields 28-32 are created from a manual entries made either by the employee into one of the badge readers 14, or by a supervisor via a personal computer 13. The last two fields 36 and 38 record the time of day and the dates when the employee entered and exited the workplace.

When an employee swipes an identification badge through a reader 14, the time and attendance software scans the existing records in the time and attendance data file 20 for an open work period record 22 for that employee, i.e. a record without data in the end time field 38. If the employee is entering the workplace, an open work period record 22 will not be found. In that case, the time and attendance software creates a new work period record 22 for that employee using the employee number read from the identification badge and by gathering data from the corresponding assignment in the work schedule data file stored elsewhere in the host computer. The current date and time of day are entered into the corresponding fields of that new record. The work period records 22 are stored chronologically according to the time that an employee arrives at work.

The next time the employee swipes the identification badge through a reader 14 upon leaving the workplace, the time and attendance program finds the open work record 22 created when the employee entered the workplace. The current time of day and the date are entered in the end time field 38 of that open record, thereby indicating that the employee has finished working. As will be described, the information stored in the start time and end time fields 36 and 38 are used to calculate the number of hours that the employee worked.

After entering an end time into a work period record 22, the time and attendance software issues a processing request to a routine that updates the employee's time and attendance record 42 that is depicted in FIG. 3. The request is placed in a queue for that routine to process. A data file 40 maintains records 42 for each employee which contains completed time data for the current pay period. The record 42 for one employee has been expanded to illustrate the items of data stored therein. Each such employee record 42 has a first field 44 that contains an identifier for that employee, such as a unique employee number. The remaining sections 46-54 of the employee record 42 contain data regarding each work period that has been completed during the relevant pay period. In the exemplary employee record 42 sections 46-52 relate to work periods that have been completed by the employee. Note that section 50 contains data for an unscheduled work period completed by the employee. The contents of these sections 46-52 are shown by the expanded second work period record 48. These data are similar to the work period data in the time and attendance file in FIG. 2 with additional fields for an indicator of whether the work period was scheduled or not and the end time field has been replaced by a field that contains the length of time worked which is calculated by the host computer from the start and end times.

Supervisors utilize the personal computer 13 to monitor attendance and the actual hours worked by employees for whom they are responsible. Additional software executed by the host computer 11, gathers selected data about employees and presents it to a given supervisor via that person's personal computer 13. The supervisor may utilize standard reports provided by the business, or may create custom reports with the specific items of information which are of interest to that supervisor. To create a custom report, the supervisor accesses the time and attendance system on the host computer 11. Initially, that system presents a menu of different system functions on the monitor of a personal computer 13 and the supervisor selects the entry to create a new report. With reference to FIG. 5, the report creation routine 60 commences at step 62 where the supervisor enters the name for the new report. The report name and other data regarding the report are stored in a report profile, as will be described. The program execution then advances to step 64 where a flag can be set if the supervisor wishes that the name of the report be visible on a pull down menu of frequently used reports. Otherwise, the report will not appear on the pull down menu. Next, at step 66, a designation can be entered indicating that this particular report should be made the default report for this supervisor, wherein it will appear automatically each time that the supervisor selects menu entry to view reports.

At step 68, a list of all the data fields that may be included in the new report is displayed on the personal computer monitor and the supervisor selects those fields which are to appear on the report being created. For example, FIG. 6 depicts a table of data 80, called an “employee view record” that is created by the report generation and distribution system for each employee who will appear on a report being generated, for example. This record has 26 data fields, any combination of which can be included on a given report. Specifically, field 81 identifies the pay group for the particular employee which identifies when the employee is paid, and field 82 contains that person's employee identification number. Field 83 stores the number of absences that the employee has occurred since a given point in time and field 84 holds the absence level which is a numerical indication of the severity of that number of absences. For example one to three absences may be level one, three to five absences level 3 and so one. This level value can be used to generate messages that alert the supervisor about employees who are chronically absent. Another pair of fields 85 and 86 provide similar information regarding the employee's tardiness.

Field 87 specifies the number of hours the employee has worked and field 88 contains the number of overtime hours worked during the respective pay period. Field 89 holds a projection of the number of overtime hours that the employee is likely to work during this pay period, and is based on the number of completed work hours and the remaining hours that the employee is scheduled to work during the current pay period. A similar projection of the total number of hours that the employee will work during the pay period is provided in field 90. Both of these projections are calculated by the conventional time and attendance system software also executed by the host computer 11. Field 91 stores a count of the number of unscheduled hours that the employee has worked, such as when the employee is called in to work during an emergency.

Fields 92, 93 and 94 hold counts of three different degrees severity of exceptions to standard work practice referred to as: information, warning and critical. The rules for whether a given event qualifies as one of these work practice exceptions are defined by the particular employer and often relate to the unique characteristics of its business and work schedules. Other rules are provided by the system software. For example, if the employee enters an end time in a work period record that is 24 hours after the start time in that record, a time violation will be recorded in the critical exception count field 92 as it is likely the employee failed to clock out the day before and now is reentering the workplace. An excessive number of absences by an employee may generate a warning exception. These various levels of exceptional situations can be used to alert supervisory personnel of potential problems in the workplace or with a particular employee.

Fields 95 and 96, respectively, contain the first and last name of the employee and that person's full name is stored in field 97. The date when the employee was hired is stored in field 98. Fields 99, 100, and 101 hold information used to contact the employee, such as an email address, home telephone number or a mobile telephone number. Additional fields 102, 103, and 104 are provided to accumulate the total number of hours worked, total overtime hours worked, and the total unscheduled hours that this employee has worked for a given pay period and pay group combination. Fields 105 and 106 hold projection of the total hours and total overtime hours that this employee is expected to work through a specified date in the future.

Referring again to FIG. 5, when the supervisor finishes selecting all the desired employee data fields at step 68, the report creation routine 60 advances to step 70 where one or more filters can be created to determine which employees are selected to have their data appear in this report. If the supervisor does not specify a filter, then all of the employees reporting to that supervisor will have information displayed in this report when it is presented on the screen of the personal computer 13. However, the supervisor typically in interested in obtaining information about only those employees who have specific attendance characteristics, such as having been tardy, having been absent, or having worked overtime. A separate filter is created for each criterion that is to be used to select an employee for this report. To create a filter the program execution advances to step 71, where a logical operator, such as AND or OR for example, is entered to designate a logic operation to be performed when a plurality of filter criteria are defined. At step 72. the particular field to be filtered is selected and then the criterion for that selection is then set at step 74. For example, if the supervisor is interested in employees who have worked more than four hours of overtime, then field 88 containing the amount of overtime hours is selected and the criterion is set at step 74 to select those employees whose value in that field is greater than four. Several filters may be created for a given report. When all of the filters have been entered, the program execution advances from step 76 to step 77.

At this point, the supervisor determines how the entries in the report are to be sorted. For example, the report may be organized alphabetically by employee names, or in descending order of how much overtime each employee worked. Thus, at step 77, the field and the order of the sort are specified. Then at step 78, the report profile is saved and the report creation routine terminates.

After saving the report, the creator may designate whether it is private for that individual's use only, or whether it will be made public and thus available for use by other persons. If it is made publicly available, other persons have read-only access and cannot alter the format of this report. As noted previously, persons other that the report creator have read-only access to published reports and cannot modify those reports. However, such a person may duplicate a published report and rename the duplicate, so that it becomes that person's report which he or she can modify as desired. Similarly, a supervisor can access any of his or her reports for editing to change the format, filter criteria, sorting or other parameters.

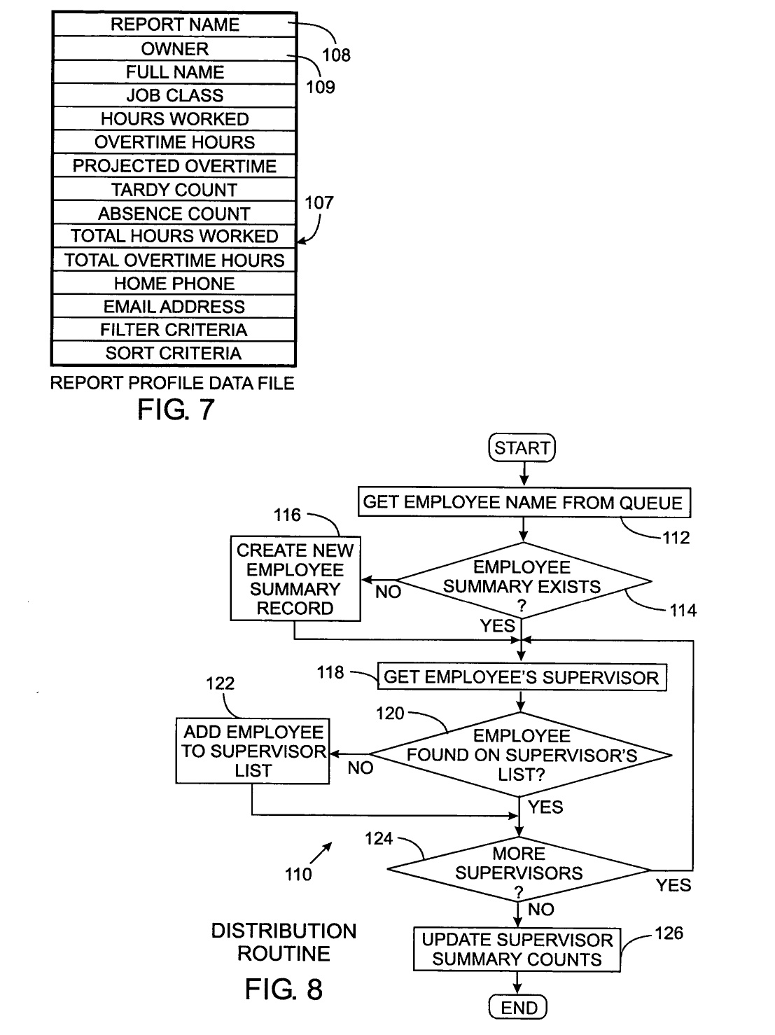

The result of the report creation process is a profile data file 107, for example as depicted in FIG. 7, which contains the report name in a field 108 that also has a flag bit which indicates whether the report is public or private. Data in another field 109 indicates the owner of the report, i.e. the supervisor who created it and may change the report profile. That latter field 109 also has flag bits indicating whether the report is visible and the default report for that supervisor. Thereafter, the profile data file 107 indicates the fields that have been selected for reporting and the filter and sort criteria.

Whenever an employee is assigned to a supervisor or a supervisor is changed, the relationship between employees and supervisors must be redefined in the report generation and distribution system so that the information for the respective employees will appear on reports of the proper supervisor. This is accomplished by a distribution routine 110 depicted by the flowchart of FIG. 8. The basic time and attendance system, such as API LaborWorkx™ mentioned previously, maintains a table that specifies the supervisor or supervisors for each employee. Whenever that table changes, the name of each affected employee is placed into the queue for the distribution routine. The distribution routine 110 responds by reading the entry from that queue at step 112. A determination is made by the host computer 11 whether a summary file exists in memory for this particular employee. If not, a new employee summary record is created at step 116. An employee summary record, as shown in FIG. 10, contains calculated information, such as the total number of different types of hours worked by the employee during the paid period.

Returning again to FIG. 8, the distribution routine then advances to step 118 at which a table maintained in the time and attendance system is queried to determine the supervisor(s) for this particular employee. At step 120, a list of the employees for the present supervisor is checked to determine if reference to the current employee is found on that a list. If such reference is not found, the program execution branches to step 122 where the employee is added to the supervisor's list. It is possible that a particular employee may report to more than one supervisor. At step 124, a determination is made by the distribution routine whether the employee is related to another supervisor in the main time and attendance system. If that is the case, the execution of the routine returns to step 118 to update that supervisor's employee list. When all the supervisor lists have been updated, the distribution routine advances to step 126 where a summary record for each supervisor is updated. As will be described, each supervisor summary record contains calculated values regarding the time and attendance for the supervisor's group of employees, such as the total amount of overtime and absences for that group. Once this supervisor summary table has been revised with data for any newly added employees, the distribution routine terminates.

One of the unique features of the present report generation and distribution system is that the data calculated for the reports is updated dynamically as the base data in the time and attendance system changes. As a consequence, this system displays the data much faster than if the report data are updated only when a report is to be displayed. One should appreciate that in a business facility having a thousand or more employees, a significant amount of computer time is required to process the thousands of time and attendance transactions to provide the requisite information for the reports. As a consequence, relatively long delays would occur between the request for a report and its display on the personal computer screen if the data was processed only in response to that request. Thus, each time an employee enters data in one of the badge readers and completes a record in the time and attendance system, that completed record is used to update the corresponding employee's summary record in the report generation and distribution system.

As described previously, upon exiting the workplace, the work period record in FIG. 2 is completed and forwarded for processing by a routine which updates the employee's records (FIG. 3) in the existing time and attendance system. The update also causes a request to be placed into a queue of the finalization routine in the report generation and distribution system. This request contains the employee identification number for the person whose time and attendance data just changed.

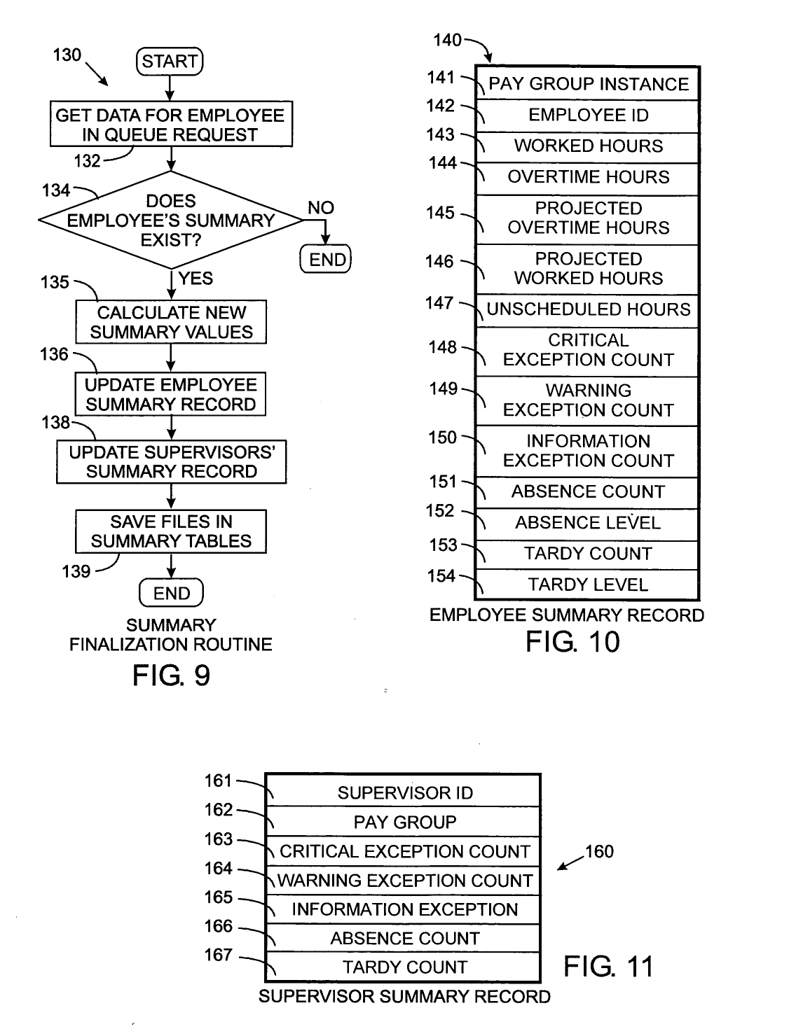

Referring to FIG. 9, the finalization routine 130 is executed by the host computer 11 whenever a request is present in the respective processing queue. Commencing at step 132 the new data are gathered for the employee identified in the queue request. A search is conducted at step 134 for the summary record of that employee. If an employee summary record is not found, as occurs when the present employee does not appear on a supervisor report, the data updating routine terminates because this employee's data are not required. However, it would be more likely that a summary record exists for the employee, in which case the routine advances to step 135 where the data gathered from the time and attendance system is employed to calculate new employee summary data values. Those newly calculated values update that person's summary record at step 136.

An example of an employee summary record 140 is depicted in FIG. 10 and includes tabulated totals for different types of work hours and other events. The first field 141 contains a designation of the pay group to which the data relates. Field 142 contains an employee identification number, while fields 143 and 144 designate the total number of hours worked and the amount of overtime hours worked during the pay period. Projections of the number of overtime hours that will occur in this work period and of the total number of hours worked are stored in fields 145 and 146, respectively. The number of unscheduled hours that the employee has worked thus far is held in field 147. Counts of events that have been defined as critical exceptions, warning exceptions and information exceptions, as described previously, are stored in fields 148, 149 and 150, respectively. The number of absences is placed in field 151 along with the absence level information in field 152. Similarly, the number of times during this work period that the employee was tardy is indicated in field 153 along with the tardy level value in field 154. Note that each field in the employee summary record 140 primarily contains dynamic data the can change as data are entered into the main time and attendance system.

Returning to the finalization routine 130 in FIG. 9, after the employee summary record 140 has been revised, the execution by the host computer advances to step 138 where the supervisor summary record is updated. An example of the data structure of a supervisor summary record 160 is illustrated in FIG. 11. Here, fields 161 and 162 contain an identification of the respective supervisor and the pay group for the data are being maintained. Aggregate counts of the critical exceptions, warning exceptions and information exceptions for the employees in that pay group are tabulated and stored in fields 163, 164 and 165. A total count of absences for those employees is contained in field 166, along with a similar aggregate tardy count in field 167. After the supervisor summary record 160 has been updated, the finalization routine 130 saves the that record in memory locations assigned to the report generation and distribution system.

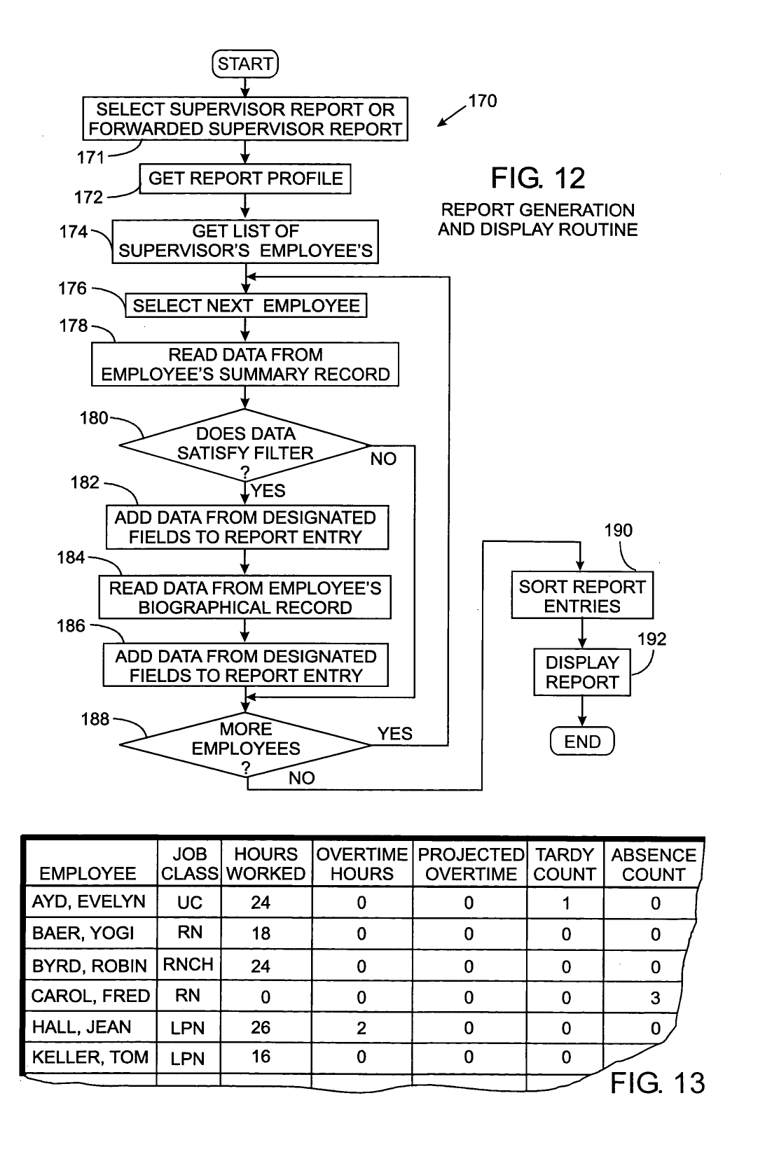

When a supervisor selects a particular report for display on a personal computer 13, the main report generation and distribution system triggers execution of a report formulation and display routine 170, depicted by the flowchart in FIG. 12. That routine commences at step 172 where the supervisor is given the option of viewing data for employees reporting to that supervisor or to another supervisor who is on leave from the workplace and has forwarded his or her report information to the present supervisor, as will be described. Then at step 172 the report profile 107 (FIG. 7) for the selected report is obtained from memory and used as defining the format for the display. Next at step 174, the list of the employees reporting to the supervisor requesting the report is obtained.

Thereafter, the data for each employee on that list is gathered and filtered, if necessary, to determine whether the data qualifies the respective employee to appear on the report. Specifically, at step 176, the next employee in the list is selected and that person's data are read from their employee summary record at step 178. Any filter defined in the report profile 107 is applied to the associated data from the employee's summary record to determine whether such data are of a type that is desired to be displayed in this report. If the filter criteria are not satisfied, execution of the report formulation and display routine 170 jumps to step 188 to ascertain whether data for other employees exist to process. Otherwise when the filter criteria are satisfied, the execution branches to steps 182-186 where an employee view record 80 (FIG. 6) is constructed for this employee. The employee view record 80 is a composite of data from several sources and commences at step 182 by transferring dynamic data from the associated employee summary record (see FIG. 10) into fields 81-94. Then at step 184 static biographical information regarding the employee is transferred into fields 95-101 of the employee view record 80 from personnel records in the host computer 11. The employee view record 80 also contains unique calculated data values in fields 102-106 that tabulate different types of work hours over several pay periods.

After the employee view record 80 is complete, a determination is made at step 188 whether additional employees appear on the supervisors list. If so, the report generation process loops back to step 176 to ascertain whether another employee should be included in the report.

When an employee view record 80 has been constructed for each employee appearing on the report being generated, the report formulation and display routine 170 branches from step 188 to step 190. At this juncture, the report entries represented by the employee view records are sorted according to the criteria in the report profile 107. Then, the report entries are displayed in this order on the personal computer 13 at step 192 with only the fields of the employee view records that are designated in the report profile 107 appearing in the displayed report.

FIG. 13 depicts an exemplary report displayed on a personal computer which uses the report profile 107 in FIG. 7. This exemplary report has the data entries sorted by employee name and provides the names of the selected data fields across the top of the report. These fields form columns with the corresponding data values for each employee entered in the box in that column. The report as displayed on the screen of a personal computer 13 (FIG. 1) may also have a field in which the viewer can enter data indicating approval of the information being displayed. For example, a supervisor viewing a report may enter an authorization code to approve the overtime hours of the employees designated in the report. After the authorization code has been entered, the supervisor presses the ENTER key on the personal computer and the information is transferred to and stored in the host computer 11. This type of data entry field can be used to input other kinds of information.

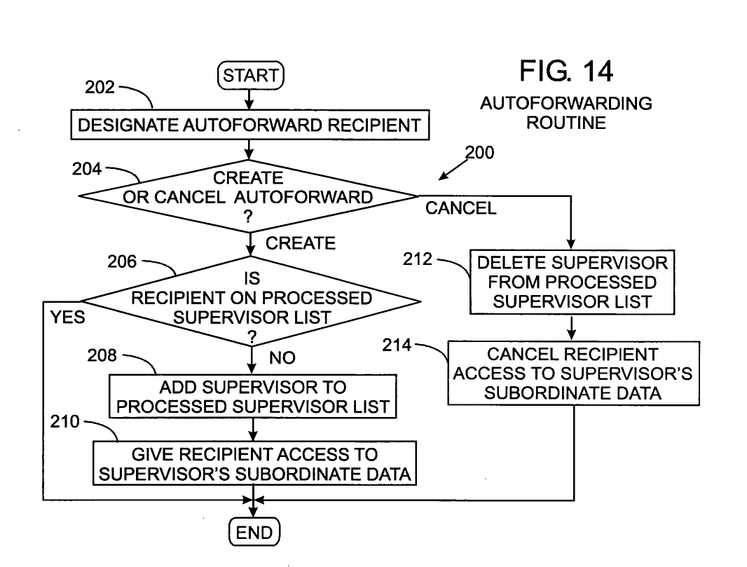

As noted previously, when a supervisor will be absent from the workplace for an extended time, such as a long vacation or sick leave, that data for that supervisor's subordinates can be automatically forwarded to another supervisor for monitoring. The process for controlling the autoforwarding is depicted in the flowchart of FIG. 14. This routine is entered by selecting the corresponding entry from the main menu of the report generation and distribution system. The autoforwarding routine 200 commences at step 202 at which the user designates the other supervisor who is to receive the data regarding the user's subordinates, this other supervisor is the recipient of the autoforwarding. Then at step 204, the user chooses whether to create an autoforward or cancel an existing autoforward.

When it is desired to create an autoforward, execution of this routine 200 branches to step 206 at which the host computer 11 checks a list of previously processed supervisors. This list contains designations of all the supervisors for whom an autoforward is currently active. This step determines whether the intended recipient for the new autoforward is on the processed supervisor list. If that is the case, the autoforwarding routine 200 ends in order to prevent circular forwarding of report data, i.e. data from a first supervisor is forwarded to a second supervisor whose data are forwarded back to the first supervisor either directly or via another supervisor. Otherwise the process advances to configure the autoforwarding at step 208 where an identifier of the present supervisor is added to the processed supervisor list. Next at step 210 the recipient is granted access to data regarding the present supervisor's subordinates after which the autoforwarding routine 200 ends.

If at step 204 the supervisor sought to cancel an existing autoforward, execution of the autoforwarding routine 200 branches to step 212 where the identifier of that supervisor is removed from the processed supervisor list. Then at step 214 the recipient's access to data regarding the present supervisor's subordinates is cancelled.

A plurality of supervisors report to a manager who is responsible for overseeing several departments of the business. A similar set of reports can be configured by which a manager is able to view the data in the supervisor summary records for those supervisors reporting to that manager. When a given report is displayed on the manager's personal computer 13, by clicking the mouse button while the cursor is on the line for a given supervisor, detailed information for that supervisor's subordinates appears on the manager's personal computer. That detailed information is gathered from the respective employee summary records in much the same manner as that data are gathered for reports displayed on the supervisor's personal computer. Thus the manager is able to view several levels of detailed information from the time and attendance system.

The foregoing description was primarily directed to preferred embodiments of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A method for generating a report from labor management data stored in a computer system for a plurality of employees, said method comprising:
storing data indicating an association of a supervisor with each employee;
creating a report profile which designates items of report data that are to appear on the report wherein the items of report data are derived from the labor management data;
for each employee, creating a summary data file having storage locations for items of report data;
whenever labor management data for a given employee changes, modifying the summary data file for the given employee by changing contents of the storage locations for the items of report data which are derived from that labor management data; and
producing a report by using the report profile and summary data files for those employees indicated as associated with a particular supervisor.

2. The method as recited in claim 1 wherein the items of report data designated by the report profile are selected from a group consisting of amount of hours worked, amount of overtime worked, amount of unscheduled hours worked, amount of absences, and amount of tardiness.

3. The method as recited in claim 1 wherein the items of report data designated by the report profile comprises a projection of an amount of overtime that an employee will work during a predefined period of time.

4. The method as recited in claim 1 wherein the report profile further designates items of employee biographical data that are to appear on the report for each employee.

5. The method as recited in claim 1 wherein the items of employee biographical data are selected from a group consisting of an employee name, a telephone number, and an email address.

6. The method as recited in claim 1 wherein the report profile further designates whether the report profile is available for use by only a person who created the report profile or also by other people.

7. The method as recited in claim 1 wherein only a given supervisor with whom an employee is associated and persons who supervise that given supervisor are able to produce a report having data for that employee.

8. The method as recited in claim 1 further comprising:
for each supervisor, creating a supervisor summary data file having storage locations for items of group data are produced by summing values of items of report data for the employees associated with the respective supervisor; and
producing a summary report from the supervisor summary data file.

9. The method as recited in claim 1 further comprising:
designating a person other the given supervisor; and
enabling that person to access the report containing data regarding the employees indicated as associated with the given supervisor.

10. The method as recited in claim 1 wherein creating a report profile comprises:
designating items of report data that are to appear on the report;
configuring a filter that defines a characteristic that a specified item of report data for an employee must possess for that employee to appear on the report; and
defining a sort parameter specifying an order in which employees are to appear on the report.

11. The method as recited in claim 10 wherein designating items of report data comprises making selections from a list of items of report data.

12. The method as recited in claim 1 further comprises displaying the report on a display device along with a field for a viewer to enter viewer input data.

13. The method as recited in claim 12 further comprises storing the viewer input data entered into the field.

14. A method by which a supervisor utilizes a computer system to generate a report from time and attendance data stored in the computer system, said method comprising:
storing an indication of a plurality of employees associated with the supervisor;
the creating a report profile which designates items of report data that are to appear on the report, wherein the items of report data are derived from the time and attendance data;
for each of the plurality of employees, creating a summary data file having storage locations for items of report data;
whenever time and attendance data for a given employee changes, modifying the summary data file for the given employee by changing contents of the storage locations for the items of report data which are derived from that time and attendance data; and
producing a report by using the report profile and summary data files for the plurality of employees.

15. The method as recited in claim 14 wherein creating a report profile comprises:
designating items of report data that are to appear on the report;
configuring a filter that defines a characteristic that a specified item of report data for an employee must possess for that employee to appear on the report; and
defining a sort parameter specifying an order in which employees are to appear on the report.

16. The method as recited in claim 14 wherein only the supervisor and persons who supervise the supervisor are able to produce a report having data for the plurality of employees associated with the supervisor.

17. The method as recited in claim 16 further comprising:
designating a person other the supervisor and persons who supervise the supervisor; and
making the report available to that person.

18. The method as recited in claim 17 further comprising:
for each supervisor, creating a supervisor summary data file having storage locations for items of group data are produced by summing values of items of report data for the employees associated with the respective supervisor; and
producing a summary report from the supervisor summary data file.

19. The method as recited in claim 14 further comprises displaying the report on a display device along with a field for a viewer to enter viewer input data; and storing the viewer input data.

20. A method for generating a report from time and attendance data for a plurality of employees wherein the data are stored in a computer system, said method comprising:
storing data indicating an association of a supervisor with each employee;
storing data indicating a person who supervises each supervisor;
creating a report profile which designates items of report data that are to appear on the report wherein the items of report data are derived from the time and attendance data;
for each employee, creating a summary data file having storage locations for items of report data;
for each supervisor, creating a supervisor summary data file having storage locations for items of group data that are produced by summing values of items of report data for the employees associated with the respective supervisor;
whenever time and attendance data for a given employee changes, modifying the summary data file for the given employee by changing contents of the storage locations for the items of report data which are derived from that time and attendance data;
modifying the supervisor summary data files in response to modifying the summary data file;
producing a report for a given supervisor by using the report profile and summary data files for those employees indicated as associated with that given supervisor; and
producing a group report using supervisor summary data files.

21. The method as recited in claim 20 wherein creating a report profile comprises:
designating items of report data that are to appear on the report;
configuring a filter that defines a characteristic that a specified item of report data for an employee must possess for that employee to appear on the report; and
defining a sort parameter specifying an order in which employees are to appear on the report.

22. The method as recited in claim 20 wherein the items of report data designated by the report profile are selected from a group consisting of amount of hours worked, amount of overtime worked, amount of unscheduled hours worked, amount of absences, amount of tardiness, a projection of an amount of overtime that an employee will work during a predefined period of time.

23. The method as recited in claim 20 further comprising:
designating a person other than the given supervisor; and
enabling the person to access the report containing data regarding the employees indicated as associated with the given supervisor.

24. The method as recited in claim 20 further comprises displaying the report on a display device along with a field for a viewer to enter viewer input data.

25. The method as recited in claim 20 further comprises displaying the group report on a display device along with a field for a viewer to enter viewer input data.
